(19) United States
(12) Patent Application Publication
(10) Pub. No.: US 2023/0128503 A1
(43) Pub. Date: Apr. 27, 2023

(54) System and Method for Lock-free Shared Data Access for Processing and Management Threads

(71) Applicant: EMC IP Holding Company, LLC, Hopkinton, MA (US)

(72) Inventors: Vitaly Zharkov, Modiin (IL); Leonid Ravich, Ra'anana (IL); Or Idgar, Kfar Saba (IL)

(21) Appl. No.: 17/511,691

(22) Filed: Oct. 27, 2021

(51) Int. Cl. G06F 9/52; G06F 16/176

(52) U.S. Cl. CPC G06F 9/522; G06F 16/1767

(57) ABSTRACT

A method, computer program product, and computing system for defining a first flow for one or more processing threads with access to shared data within the storage system. The one or more processing threads may be executed using the first flow. A processing thread reference count may be determined for the one or more processing threads being executed using the first flow. One or more management threads may be executed on the shared data within the storage system based upon, at least in part, the processing thread reference count.

### BACKGROUND

Storing and safeguarding electronic content may be beneficial in modern business and elsewhere. Accordingly, various methodologies may be employed to protect and distribute such electronic content.

In multi-threaded programming, data often is shared between threads. If data is simultaneously written to by several threads, it can cause corruption. If data is read from one thread while it is being written to by another, the reading thread can get incomplete data. To prevent such situations, called races, various synchronization mechanisms exist. For example, a lock mechanism may suspend access to the data by one thread while it is used by another. Synchronization mechanisms cause additional latency to the execution flow. In applications where performance is critical (e.g., data path of storage applications), the latency added by synchronization mechanism may be significant. Moreover, suspending threads is not always needed because threads may have an alternative path to access the shared data. For various data handling requirements, different kinds of synchronization mechanisms may be used.

### SUMMARY OF DISCLOSURE

In one example implementation, a computer-implemented method executed on a computing device may include, but is not limited to, defining a first flow for one or more processing threads with access to shared data within the storage system. The one or more processing threads may be executed using the first flow. A processing thread reference count may be determined for the one or more processing threads being executed using the first flow. One or more management threads may be executed on the shared data within the storage system based upon, at least in part, the processing thread reference count.

One or more of the following example features may be included. A second flow for the one or more processing threads without access to the shared data within the storage system may be defined. A request to execute the one or more management threads on the shared data within the storage system may be received. The execution of the one or more processing threads may be switched from the first flow to the second flow. Determining a processing thread reference count for the one or more processing threads being executed using the first flow may include defining an incoming counter for each processing thread beginning access to the shared data within the storage system, thus defining an incoming counter value; and defining an outgoing counter for each processing thread ending access to the shared data within the storage system, thus defining an outgoing counter value. Executing one or more management threads on the shared data within the storage system based upon, at least in part, the processing thread reference count may include executing the one or more management threads on the shared data within the storage system when the incoming counter value for each processing thread is less than the outgoing counter value for each processing thread. Determining a processing thread reference count for the one or more processing threads being executed using the first flow may include defining a dedicated incoming counter/outgoing counter pair for each processing thread.

In another example implementation, a computer program product resides on a computer readable medium that has a plurality of instructions stored on it. When executed by a processor, the instructions cause the processor to perform operations that may include, but are not limited to, defining a first flow for one or more processing threads with access to shared data within the storage system. The one or more processing threads may be executed using the first flow. A processing thread reference count may be determined for the one or more processing threads being executed using the first flow. One or more management threads may be executed on the shared data within the storage system based upon, at least in part, the processing thread reference count.

One or more of the following example features may be included. A second flow for the one or more processing threads without access to the shared data within the storage system may be defined. A request to execute the one or more management threads on the shared data within the storage system may be received. The execution of the one or more processing threads may be switched from the first flow to the second flow. Determining a processing thread reference count for the one or more processing threads being executed using the first flow may include defining an incoming counter for each processing thread beginning access to the shared data within the storage system, thus defining an incoming counter value; and defining an outgoing counter for each processing thread ending access to the shared data within the storage system, thus defining an outgoing counter value. Executing one or more management threads on the shared data within the storage system based upon, at least in part, the processing thread reference count may include executing the one or more management threads on the shared data within the storage system when the incoming counter value for each processing thread is less than the outgoing counter value for each processing thread. Determining a processing thread reference count for the one or more processing threads being executed using the first flow may include defining a dedicated incoming counter/outgoing counter pair for each processing thread.

In another example implementation, a computing system includes at least one processor and at least one memory architecture coupled with the at least one processor, wherein the at least one processor is configured to define a first flow for one or more processing threads with access to shared data within the storage system. The at least one processor may be further configured to execute the one or more processing threads using the first flow. The at least one processor may be further configured to determine a processing thread reference count for the one or more processing threads being executed using the first flow. The at least one processor may be further configured to execute one or more management threads on the shared data within the storage system based upon, at least in part, the processing thread reference count.

One or more of the following example features may be included. A second flow for the one or more processing threads without access to the shared data within the storage system may be defined. A request to execute the one or more management threads on the shared data within the storage system may be received. The execution of the one or more processing threads may be switched from the first flow to the second flow. Determining a processing thread reference count for the one or more processing threads being executed using the first flow may include defining an incoming counter for each processing thread beginning access to the shared data within the storage system, thus defining an incoming counter value; and defining an outgoing counter for each processing thread ending access to the shared data within the storage system, thus defining an outgoing counter value. Executing one or more management threads on the shared data within the storage system based upon, at least in part, the processing thread reference count may include executing the one or more management threads on the shared data within the storage system when the incoming counter value for each processing thread is less than the outgoing counter value for each processing thread. Determining a processing thread reference count for the one or more processing threads being executed using the first flow may include defining a dedicated incoming counter/outgoing counter pair for each processing thread.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a shared data access process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of shared data access process according to one or more example implementations of the disclosure;

FIG. 4 is an example diagrammatic view of the execution of processing threads and management threads on shared data within the storage system of FIG. 1 according to one or more example implementations of the disclosure; and

FIGS. 5A and 5B are example diagrammatic views of shared data within a storage system that may be accessed by processing threads and management threads according to one or more example implementations of the disclosure.

Like reference symbols in the various drawings indicate like elements.

### DETAILED DESCRIPTION

### System Overview

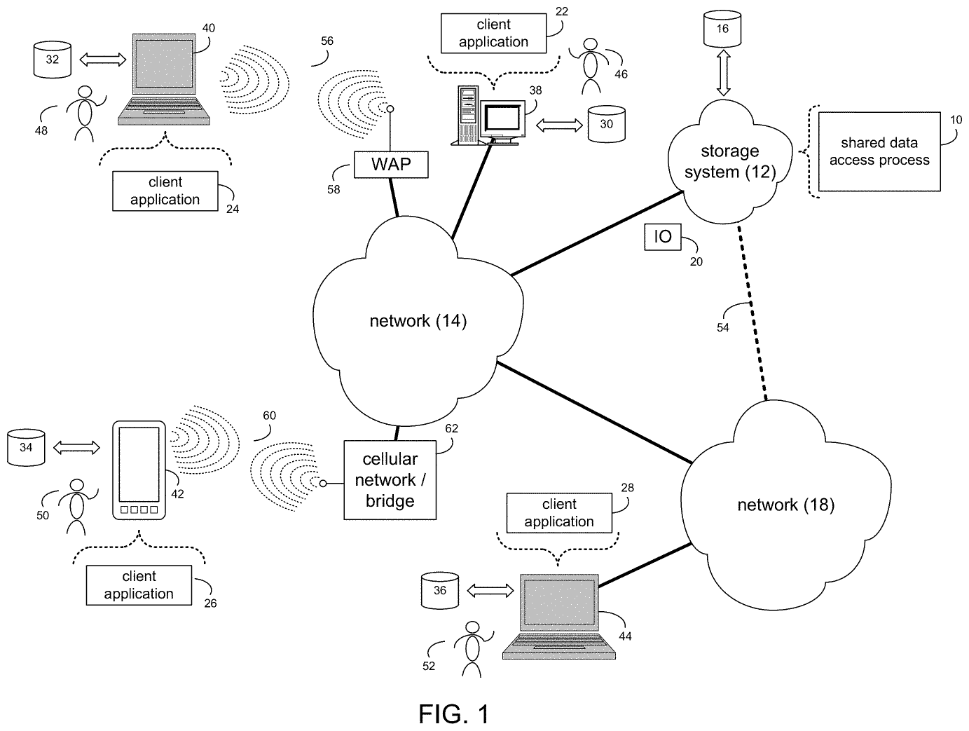

Referring to FIG. 1, there is shown shared data access process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of shared data access process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of shared data access process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a shared data access process, such as shared data access process 10 of FIG. 1, may include but is not limited to, defining a first flow for one or more processing threads with access to shared data within a storage system. The one or more processing threads may be executed using the first flow. A processing thread reference count may be determined for the one or more processing threads being executed using the first flow. One or more management threads may be executed on the shared data within the storage system based upon, at least in part, the processing thread reference count.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

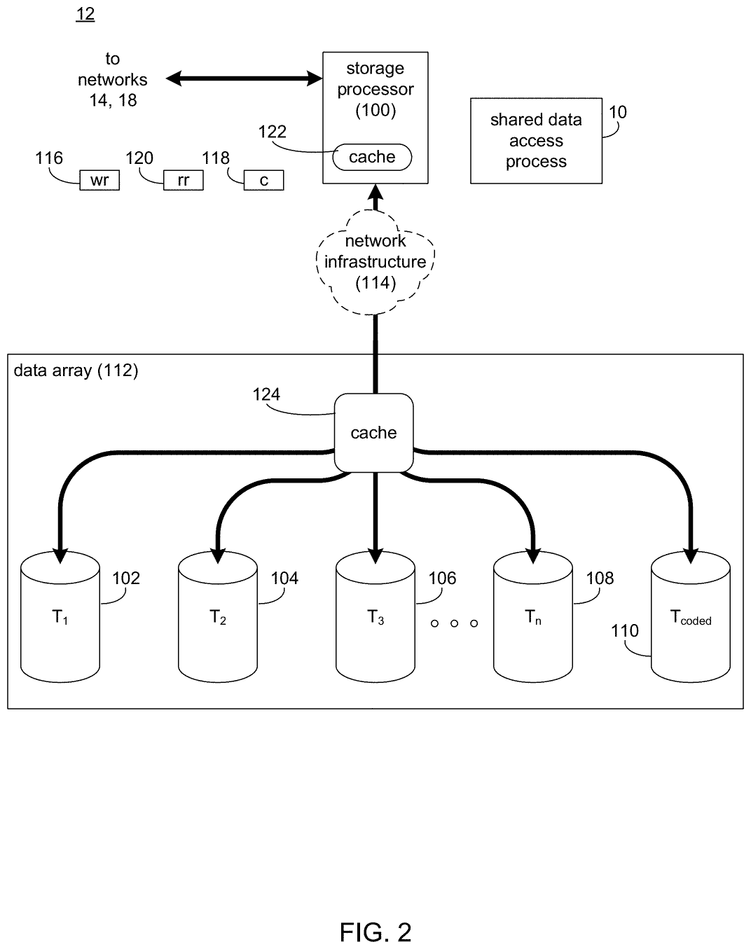

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of shared data access process 10. The instruction sets and subroutines of shared data access process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of shared data access process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of shared data access process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of shared data access process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Shared Data Access Process

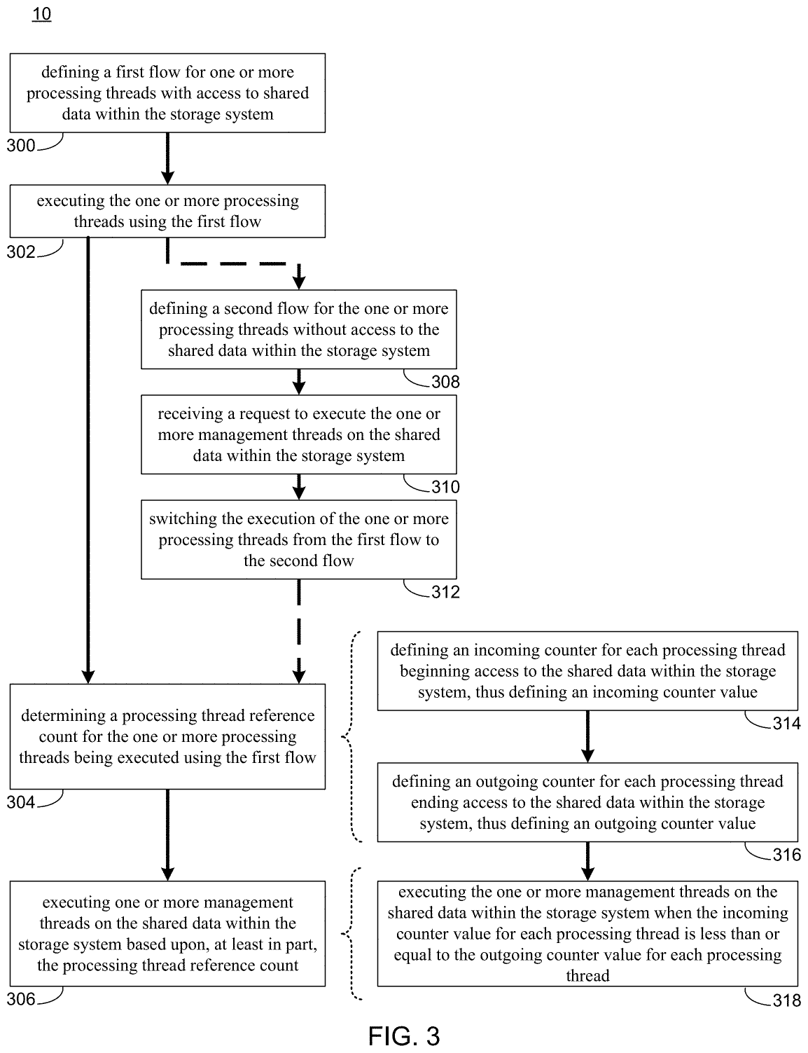

Referring also to the examples of FIGS. 3-5B and in some implementations, shared data access process 10 may define 300 a first flow for one or more processing threads with access to shared data within a storage system. The one or more processing threads may be executed 302 using the first flow. A processing thread reference count may be determined 304 for the one or more processing threads being executed using the first flow. One or more management threads may be executed 306 on the shared data within the storage system based upon, at least in part, the processing thread reference count.

As will be discussed in greater detail below, implementations of the present disclosure may allow for lock-free shared data access by processing threads and management threads. In multi-threaded programming, data often is shared between threads. If data is simultaneously written to by several threads, it can cause corruption. If data is read from one thread while it is being written to by another, the reading thread can get incomplete data. To prevent such situations, called races, various synchronization mechanisms exist. For example, a lock mechanism may suspend access to the data by one thread while it is used by another. Synchronization mechanisms cause additional latency to the execution flow. In applications where performance is critical (e.g., data path of storage applications), the latency added by synchronization mechanism may be significant. Moreover, suspending threads is not always needed because threads may have an alternative path to access the shared data. For various data handling requirements, different kinds of synchronization mechanisms may be used.

For optimal utilization of storage system resources, IO operations may be processed in parallel by several threads (i.e., processing threads). Along with processing threads, a storage system may execute management threads to perform various management operations on data within the storage system. In some instances, the processing threads and the management threads may process the same data (i.e., shared data). For example, both processing threads and management threads can update and read the shared data. While it may be appropriate to assume that management thread operations are less frequent, simultaneous access to the shared data may result in shared data corruption or incompleteness. Accordingly, shared data access process 10 may provide lock-free shared data access to optimize the performance of the processing threads while allowing management threads to be executed on the shared data.

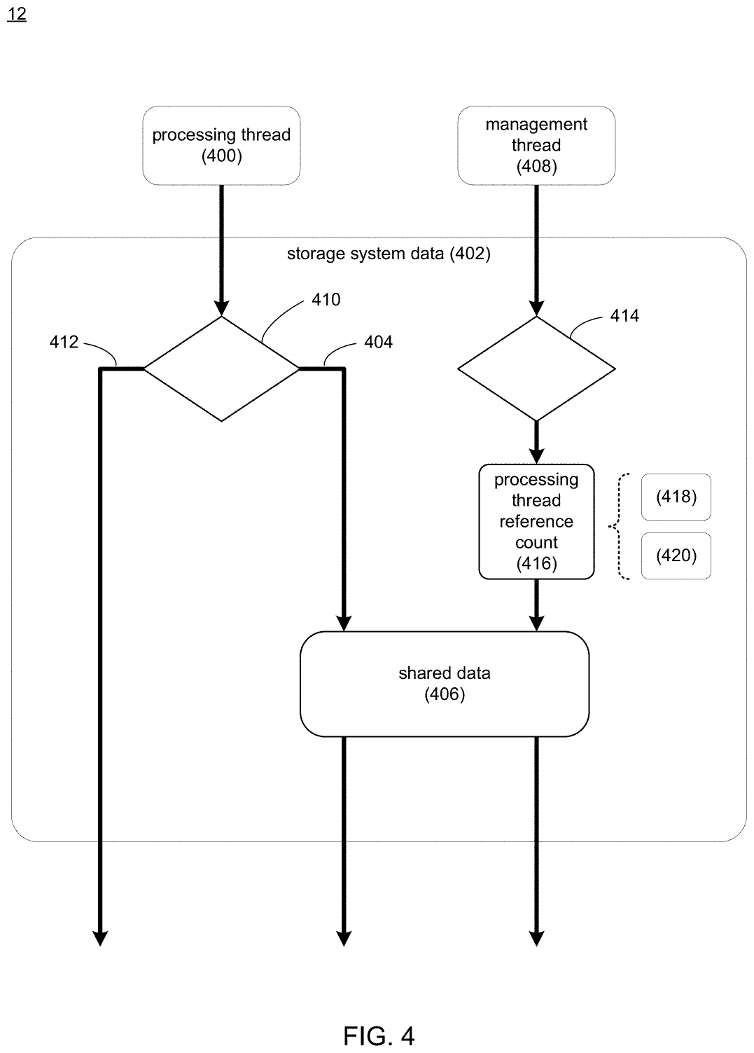

In some implementations, shared data access process 10 may define 300 a first flow for one or more processing threads with access to shared data within a storage system. A flow may generally include an access path through storage system data or storage system code that is utilized by a thread during execution. Referring also to FIG. 4, shared data access process 10 may process one or more IO requests (e.g., IO request 20) in parallel using various processing threads (e.g., processing thread 400). Processing thread 400 may access storage system data (e.g., storage system data 402) using various flows. As shown in FIG. 4, shared data access process 10 may define 300 a first flow (e.g., flow 404) with access to shared data (e.g., shared data 406) within the storage system (e.g., storage system 12). Shared data (e.g., shared data 406) may include any storage system data (e.g., storage system data 402) that is or may be accessed by one or more processing threads (e.g., processing thread 400) and one or more management threads (e.g., management thread 408). In this manner, the shared data (e.g., shared data 406) may be “shared” by both the one or more processing threads (e.g., processing thread 400) and the one or more management threads (e.g., management thread 408).

As shown in FIG. 4, the first flow (e.g., flow 404) may include a data path through the storage system data (e.g., storage system data 402) that includes access to the shared data (e.g., shared data 406). As discussed above, the data path through the storage system data (e.g., storage system data 402) may include the portions of code within the storage system data (e.g., storage system data 402) that may be accessed by the one or more processing threads (e.g., processing thread 400) during execution. As shown in FIG. 4, the first flow (e.g., flow 404) may include access to the portions of code within the storage system data (e.g., storage system data 402) that are shared or may be shared with one or more management threads (e.g., management thread 408). Accordingly, it will be appreciated that the scope of shared data (e.g., shared data 406) may change depending upon the data accessed by the one or more processing threads (e.g., processing thread 400) and the one or more management threads (e.g., management thread 408).

In some implementations, shared data access process 10 may execute 302 the one or more processing threads using the first flow. Executing 302 the one or more processing threads (e.g., processing thread 400) using the first flow (e.g., flow 404) may include executing the operations on the storage system data (e.g., storage system data 402) including the shared data (e.g., shared data) specified by the one or more processing threads (e.g., processing thread 400). As will be discussed in greater detail below, executing 302 the one or more processing threads (e.g., processing thread 400) using the first flow (e.g., flow 404) may include marking the processing thread (e.g., processing thread 400) as referenced, checking a switching condition (e.g., switch 410) associated with the processing thread, accessing the shared data (e.g., shared data 406), and unmarking the processing thread (e.g., processing thread 400) as referenced.

In some implementations, shared data access process 10 may define 308 a second flow for the one or more processing threads without access to the shared data within the storage system. Referring again to FIG. 4, shared data access process 10 may define 308 a second flow (e.g., flow 412) without access to shared data (e.g., shared data 406) within the storage system (e.g., storage system 12). The second flow (e.g., flow 412) may include a data path through the storage system data (e.g., storage system data 402) that does not include access to the shared data (e.g., shared data 406). As discussed above, the data path through the storage system data (e.g., storage system data 402) may include the portions of code within the storage system data (e.g., storage system data 402) that may be accessed by the one or more processing threads (e.g., processing thread 400) during execution. By defining 308 a second flow, shared data access process 10 may allow the one or more processing threads (e.g., processing thread 400) to be executed with the second flow (e.g., flow 412) without utilizing any locking mechanisms. In this manner, shared data access process 10 may allow one or more management threads (e.g., management thread 408) to be executed on the shared data (e.g., shared data 406) when the execution of the one or more processing threads (e.g., processing thread 400) is switched from the first flow (e.g., first flow 404) to the second flow (e.g., second flow 412) without any locking mechanisms.

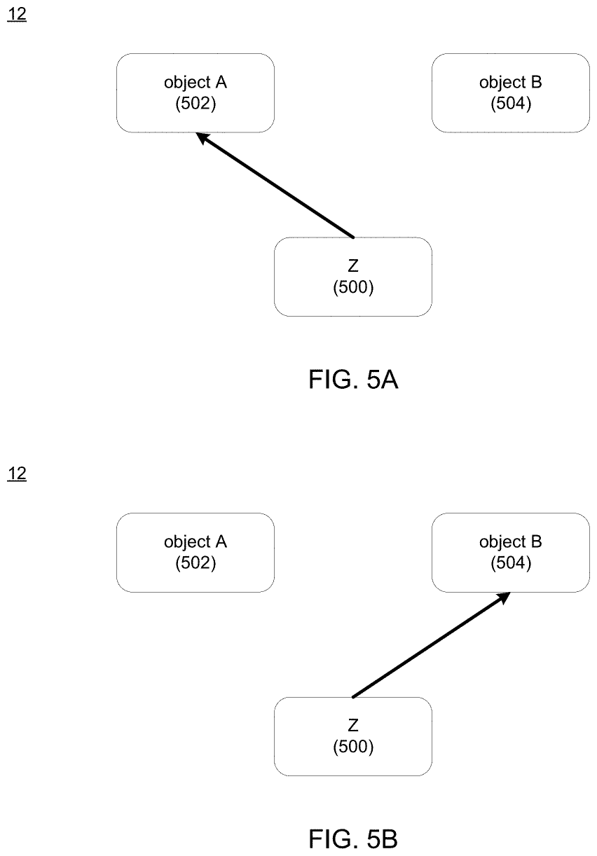

In some implementations, shared data access process 10 may receive 310 a request to execute the one or more management threads on the shared data within the storage system. As discussed above, the one or more management threads (e.g., management thread 408) may generally include a thread configured to perform internal, data management operations on the storage system data (e.g., storage system data 402). Referring also to FIG. 5A, suppose storage system data 402 includes pointer Z (e.g., pointer Z 500) which points to object A (e.g., object A 502). In this example, suppose that shared data access process 10 executes 302 one or more processing threads (e.g., processing thread 400) referencing object A (e.g., object A 502) using pointer Z. Now suppose that shared data access process 10 receives 310 a request to execute one or more management threads (e.g., management thread 408) on pointer Z (e.g., pointer Z 500). In this example, when executed, management thread 408 may change the reference of pointer Z 500 to point to object B (e.g., object B 504) and free object A 502. Accordingly, pointer Z (e.g., pointer 500) may be shared data relative to the one or more processing threads (e.g., processing thread 400) and the one or more management threads (e.g., management thread 408).

In some implementations, shared data access process 10 may switch 312 the execution of the one or more processing threads from the first flow to the second flow. For example and referring again to FIG. 4, in response to receiving 310 the one or more management threads (e.g., management thread 408), shared data access process 10 may switch 312 the execution of the one or more processing threads (e.g., processing thread 400) from the first flow (e.g., flow 404) to the second flow (e.g., second flow 412). Shared data access process 10 may activate switch logic (e.g., switch logic 414) that changes the switch (e.g., switch 410) checked by the one or more processing threads (e.g., processing thread 400) to determine which flow to utilize for executing. In this example, shared data access process 10 may switch 312 the execution of the one or more processing threads (e.g., processing thread 400) from the first flow (e.g., flow 404) to the second flow (e.g., flow 412).

In some implementations, shared data access process 10 may determine 304 a processing thread reference count for the one or more processing threads being executed using the first flow. Continuing with the example of FIG. 5A, suppose that shared data access process 10 switches 312 the execution of the one or more processing threads (e.g., processing thread 400) from the first flow (e.g., flow 404) to the second flow (e.g., second flow 412). While future processing threads may be switched from accessing pointer Z 500, it may be unclear whether any ongoing processing threads are still accessing object A 502. Accordingly, shared data access process 10 may provide a lock-free processing thread reference count to determine whether any processing threads are still accessing the shared data (e.g., pointer Z 500). A processing thread reference count (e.g., processing thread reference count 416) may indicate the number of processing threads that are marked as referencing or accessing the shared data compared to the number of processing threads that are unmarked.

Determining 304 a processing thread reference count for the one or more processing threads being executed using the first flow may include defining 314 an incoming counter for each processing thread beginning access to the shared data within the storage system, thus defining an incoming counter value; and defining 316 an outgoing counter for each processing thread ending access to the shared data within the storage system, thus defining an outgoing counter value. For example, shared data access process 10 may mark each processing thread (e.g., processing thread 400) as referenced by incrementing an “incoming counter”. The incoming counter (e.g., incoming counter 418) may indicate that a processing thread (e.g., processing thread 400) is beginning access to the shared data (e.g., shared data 406). Accordingly, shared data access process 10 may define 314 an incoming counter value based upon, at least in part, the value of the incoming counter (e.g., incoming counter 418).

Shared data access process 10 may define 316 an outgoing counter for each processing thread ending access to the shared data within the storage system, thus defining an outgoing counter value. For example, shared data access process 10 may mark each processing thread (e.g., processing thread 400) as unreferenced by incrementing an “outgoing counter”. The outgoing counter (e.g., outgoing counter 420) may indicate that a processing thread (e.g., processing thread 400) is ending access to the shared data (e.g., shared data 406). Accordingly, shared data access process 10 may define an outgoing counter value based upon, at least in part, the value of the outgoing counter (e.g., outgoing counter 420). For example, when a processing thread (e.g., processing thread 400) begins accessing the shared data (e.g., shared data 406), shared data access process 10 may increment the incoming counter (e.g., incoming counter 418) to define the incoming counter value. When the processing thread (e.g., processing thread 400) ends accessing the shared data (e.g., shared data 406), shared data access process 10 may increment the outgoing counter (e.g., outgoing counter 420) to define the outgoing counter value.

Determining 304 a processing thread reference count for the one or more processing threads being executed using the first flow may include defining 318 a dedicated incoming counter/outgoing counter pair for each processing thread. For example, shared data access process 10 may receive multiple processing threads for executing on the shared data. Accordingly, shared data access process 10 may define 318 a dedicated incoming counter (e.g., incoming counter 418)/outgoing counter (e.g., outgoing counter 420) pair for each processing thread (e.g., processing thread 400). In this manner, shared data access process 10 may determine whether any processing thread of a plurality of processing threads is accessing the shared data (e.g., shared data 406) when one or more management threads (e.g., management thread 408) is received.

In some implementations, shared data access process 10 may execute 306 one or more management threads on the shared data within the storage system based upon, at least in part, the processing thread reference count. For example, shared data access process 10 may utilize the processing thread reference count (e.g., processing thread reference count 416) to determine whether or not to execute 306 the one or more management threads (e.g., management thread 408) on the shared data (e.g., shared data 406). Shared data access process 10 may perform a synchronization operation using the processing thread reference count (e.g., processing thread reference count 416) to determine whether or not to execute 306 the one or more management threads (e.g., management thread 408) on the shared data (e.g., shared data 406).

Executing 306 one or more management threads on the shared data within the storage system based upon, at least in part, the processing thread reference count may include executing 320 the one or more management threads on the shared data within the storage system when the incoming counter value for each processing thread is less than or equal to the outgoing counter value for each processing thread. For example, shared data access process 10 may perform a comparison of the incoming counter value for each processing thread and the outgoing counter value for each processing thread to determine whether or not to execute 320 the one or more management threads (e.g., management thread 408) on the shared data (e.g., shared data 406).

Referring again to the example of FIG. 5A, suppose that shared data access process 10 receives a request to execute one or more management threads (e.g., management thread 408) to change pointer Z 500 to point to object B 504. Further suppose that shared data access process 10 defines 314 an incoming counter (e.g., incoming counter 418) and defines 316 an outgoing counter (e.g., outgoing counter 420) for the one or more processing threads (e.g., processing thread 400) on the shared data (e.g., pointer Z 500). In this example, further suppose that shared data access process 10 defines an incoming counter value of e.g., 21 and an outgoing counter value of e.g., 20. Accordingly, shared data access process 10 may determine that e.g., one or more processing threads are still accessing the shared data (e.g., pointer Z 500). Accordingly, shared data access process 10 may periodically re-determine whether the incoming counter value for each processing thread is less than or equal to the outgoing counter value for each processing thread.

Now suppose that after some period of time, shared data access process 10 defines 314 an incoming counter value of e.g., 20 and defines 316 an outgoing counter value of e.g., 20. In this example, shared data access process 10 may execute 320 the one or more management threads (e.g., management thread 408) on the shared data (e.g., pointer Z 500) because the incoming counter value for each processing thread is less than or equal to the outgoing counter value for each processing thread. Accordingly, shared data access process 10 may execute 320 the one or more management threads (e.g., management thread 408) on the shared data (e.g., pointer Z 500) as shown in FIG. 5B without utilizing a locking mechanism and/or by increasing storage system latency.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
defining a first flow for one or more processing threads with access to shared data within the storage system;
executing the one or more processing threads using the first flow;
determining a processing thread reference count for the one or more processing threads being executed using the first flow; and
executing one or more management threads on the shared data within the storage system based upon, at least in part, the processing thread reference count.

2. The computer-implemented method of claim 1, further comprising:
defining a second flow for the one or more processing threads without access to the shared data within the storage system.

3. The computer-implemented method of claim 2, further comprising:
receiving a request to execute the one or more management threads on the shared data within the storage system.

4. The computer-implemented method of claim 3, further comprising:
switching the execution of the one or more processing threads from the first flow to the second flow.

5. The computer-implemented method of claim 1, wherein determining a processing thread reference count for the one or more processing threads being executed using the first flow includes:
defining an incoming counter for each processing thread beginning access to the shared data within the storage system, thus defining an incoming counter value; and
defining an outgoing counter for each processing thread ending access to the shared data within the storage system, thus defining an outgoing counter value.

6. The computer-implemented method of claim 5, wherein executing one or more management threads on the shared data within the storage system based upon, at least in part, the processing thread reference count includes:
executing the one or more management threads on the shared data within the storage system when the incoming counter value for each processing thread is less than or equal to the outgoing counter value for each processing thread.

7. The computer-implemented method of claim 5, wherein determining a processing thread reference count for the one or more processing threads being executed using the first flow includes:
defining a dedicated incoming counter/outgoing counter pair for each processing thread.

8. A computer program product residing on a non-transitory computer readable medium having a plurality of instructions stored thereon which, when executed by a processor, cause the processor to perform operations comprising:
defining a first flow for one or more processing threads with access to shared data within the storage system;
executing the one or more processing threads using the first flow;
determining a processing thread reference count for the one or more processing threads being executed using the first flow; and
executing one or more management threads on the shared data within the storage system based upon, at least in part, the processing thread reference count.

9. The computer program product of claim 8, wherein the operations further comprise:
defining a second flow for the one or more processing threads without access to the shared data within the storage system.

10. The computer program product of claim 9, wherein the operations further comprise:
receiving a request to execute the one or more management threads on the shared data within the storage system.

11. The computer program product of claim 10, wherein the operations further comprise:
switching the execution of the one or more processing threads from the first flow to the second flow.

12. The computer program product of claim 8, wherein determining a processing thread reference count for the one or more processing threads being executed using the first flow includes:
defining an incoming counter for each processing thread beginning access to the shared data within the storage system, thus defining an incoming counter value; and
defining an outgoing counter for each processing thread ending access to the shared data within the storage system, thus defining an outgoing counter value.

13. The computer program product of claim 12, wherein executing one or more management threads on the shared data within the storage system based upon, at least in part, the processing thread reference count includes:
executing the one or more management threads on the shared data within the storage system when the incoming counter value for each processing thread is less than the outgoing counter value for each processing thread.

14. The computer program product of claim 12, wherein determining a processing thread reference count for the one or more processing threads being executed using the first flow includes:
defining a dedicated incoming counter/outgoing counter pair for each processing thread.

15. A computing system comprising:
a memory; and
a processor configured to define a first flow for one or more processing threads with access to shared data within the storage system, wherein the processor is further configured to execute the one or more processing threads using the first flow, wherein the processor is further configured to determine a processing thread reference count for the one or more processing threads being executed using the first flow, and wherein the processor is further configured to execute one or more management threads on the shared data within the storage system based upon, at least in part, the processing thread reference count.

16. The computing system of claim 15, wherein the processor is further configured to:
define a second flow for the one or more processing threads without access to the shared data within the storage system.

17. The computing system of claim 16, wherein the processor is further configured to:
receive a request to execute the one or more management threads on the shared data within the storage system

18. The computing system of claim 17, wherein the processor is further configured to:
switch the execution of the one or more processing threads from the first flow to the second flow.

19. The computing system of claim 15, wherein determining a processing thread reference count for the one or more processing threads being executed using the first flow includes:
defining an incoming counter for each processing thread beginning access to the shared data within the storage system, thus defining an incoming counter value; and
defining an outgoing counter for each processing thread ending access to the shared data within the storage system, thus defining an outgoing counter value.

20. The computing system of claim 19, wherein executing one or more management threads on the shared data within the storage system based upon, at least in part, the processing thread reference count includes:
executing the one or more management threads on the shared data within the storage system when the incoming counter value for each processing thread is less than the outgoing counter value for each processing thread.
